(19) United States
(12) Patent Application Publication
(10) Pub. No.: US 2024/0397352 A1
(43) Pub. Date: Nov. 28, 2024

(54) METHOD FOR ASSESSING CHANNEL QUALITY AND NETWORK SYSTEM

(71) Applicant: REALTEK SEMICONDUCTOR CORP., Hsinchu (TW)

(72) Inventor: CHI-SHENG WANG, HSINCHU (TW)

(21) Appl. No.: 18/368,610

(22) Filed: Sep. 15, 2023

(30) Foreign Application Priority Data
May 26, 2023 (TW) 112119592

(51) Int. Cl. H04W 24/08

(52) U.S. Cl. CPC H04W 24/08

(57) ABSTRACT

A method for assessing a channel quality and a network system are provided. The network system includes a network device and a plurality of mobile stations. The network device and the mobile stations wirelessly communicate with each other through a plurality of channels. The method includes the following steps: configuring the network device to divide the channels into a plurality of channel groups according to the corresponding mobile stations; configuring the network device to send at least one packet through each of the channel groups to the corresponding mobile station for channel measurement, so as to obtain a plurality of quality parameters respectively for the channels; and configuring the mobile stations to transmit the quality parameters back to the network device, and configuring the network device to assess a communication quality of the channels based on the received quality parameters.

### CROSS-REFERENCE TO RELATED PATENT APPLICATION

This application claims the benefit of priority to Taiwan Patent Application No. 112119592, filed on May 26, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to channel assessment, and more particularly to a method for assessing a channel quality and a network system in which a mobile station (MS) is configured to perform channel measurement based on a packet sent by a network device through a channel group and transmit quality parameters back to the network device, thereby reducing a downtime of the network device.

### BACKGROUND OF THE DISCLOSURE

Generally speaking, a network device (e.g., a wireless access point) needs to stop providing service when assessing a communication quality of channels, and switches to different channels for channel measurement, so as to obtain quality parameters (e.g., a channel utilization rate) of each channel. However, as bandwidths that are used are becoming wider, there are more and more channels that need to be measured. As a result, a downtime of the network device becomes longer, which can easily cause discontinuities in data transmission.

### SUMMARY OF THE DISCLOSURE

In response to the above-referenced technical inadequacies, the present disclosure provides a method for assessing a channel quality and a network system in which a mobile station is configured to perform channel measurement based on a packet sent by a network device through a channel group and transmit quality parameters back to the network device, thereby reducing a downtime of the network device.

In order to solve the above-mentioned problems, one of the technical aspects adopted by the present disclosure is to provide a method for assessing a channel quality, which is applicable to a network system that includes a network device and a plurality of mobile stations. The network device and the mobile stations wirelessly communicate with each other through a plurality of channels. The method includes: configuring the network device to divide the channels into a plurality of channel groups according to the corresponding mobile stations; configuring the network device to send at least one packet through each of the channel groups to the corresponding mobile station for channel measurement, so as to obtain a plurality of quality parameters respectively for the channels; and configuring the mobile stations to transmit the quality parameters back to the network device, and configuring the network device to assess a communication quality of the channels based on the received quality parameters.

In order to solve the above-mentioned problems, another one of the technical aspects adopted by the present disclosure is to provide a network system, which includes a plurality of mobile stations and a network device. The network device and the mobile stations wirelessly communicate with each other through a plurality of channels. The network device is configured to perform the following steps: dividing the channels into a plurality of channel groups according to the corresponding mobile stations; sending at least one packet through each of the channel groups to the corresponding mobile station for channel measurement, so as to obtain a plurality of quality parameters respectively for the channels; and assessing a communication quality of the channels based on the received quality parameters. The mobile stations are configured to transmit the quality parameters back to the network device.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for assessing a channel quality according to one embodiment of the present disclosure;

FIG. 2 is a schematic view of a network system according to one embodiment of the present disclosure;

FIG. 3 is a schematic view showing eleven channels in a 5 GHz wireless network being evenly divided into two channel groups that respectively correspond to two mobile stations according to one embodiment of the present disclosure with the eleven channels having a 40 MHz bandwidth; and

FIG. 4 is a schematic view showing each channel group including (m/n) channels according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

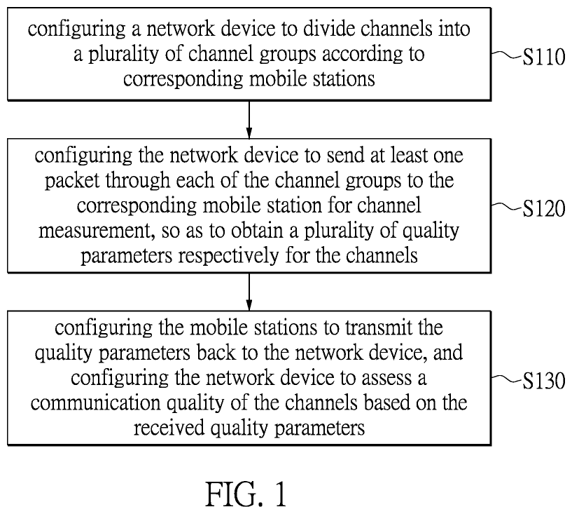

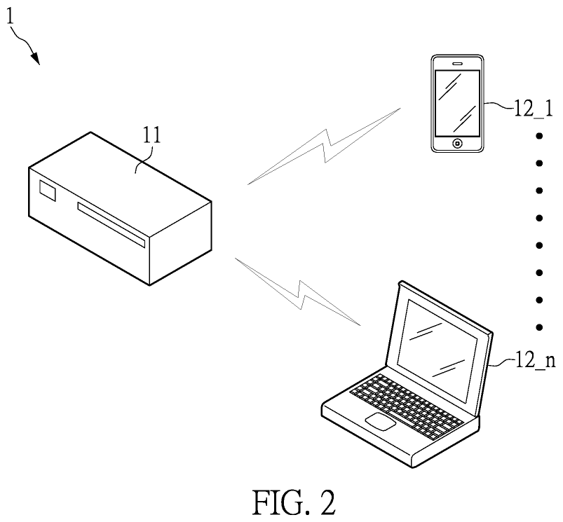

Reference is made to FIG. 1 and FIG. 2, in which FIG. 1 is a flowchart of a method for assessing a channel quality according to one embodiment of the present disclosure, and FIG. 2 is a schematic view of a network system according to one embodiment of the present disclosure. As shown in FIG. 2, a network system 1 of the present disclosure includes a network device 11 and a plurality of mobile stations 12_1 to 12_n. In addition, the network device 11 and the mobile stations 12_1 to 12_n wirelessly communicate with each other through a plurality of channels CH_1 to CH_m (not illustrated in FIG. 2). That is to say, m and n are each an integer greater than 1. However, the channels CH_1 to CH_m and the mobile stations 12_1 to 12_n are not limited to specific quantities in the present disclosure.

Specifically, the network device 11 can be a wireless access point that includes a processor and a transceiver, and each of the mobile stations 12_1 to 12_n can be user equipment (UE) that includes a processor, a transceiver, and a channel measuring device, such as a smartphone, a laptop, a tablet, or an IoT device. However, specific implementations of the network device 11 and the mobile stations 12_1 to 12_n are not limited in the present embodiment. It should be noted that the method of the present disclosure is applicable to the network system 1 that includes the network device 11 and the mobile stations 12_1 to 12_n, and includes the following steps.

Step S110: configuring a network device to divide channels into a plurality of channel groups according to corresponding mobile stations. Specifically, each of the channel groups corresponds to one of the mobile stations, and includes at least one of the channels.

Step S120: configuring the network device to send at least one packet through each of the channel groups to the corresponding mobile station for channel measurement, so as to obtain a plurality of quality parameters respectively for the channels.

Taking one of the channel groups for example, the network device can send the packet through all the channels within said channel group to the mobile station that corresponds to said channel group. Furthermore, in the present embodiment, the mobile station that corresponds to said channel group is configured to perform the channel measurement based on the received packet, so as to obtain the quality parameters of all the channels within said channel group. As such, after the mobile stations have completed the channel measurement for all the channels within all the channel groups, the quality parameters of all the channels within all the channel groups can be obtained in the present embodiment.

It should be noted that the so-called channel measurement includes a step of using at least one algorithm to calculate the quality parameters that reflect a communication quality based on the received packet. Specifically, the mobile station can perform the above-mentioned step through its processor and channel measuring device, so as to obtain the quality parameters that reflect the communication quality.

Step S130: configuring the mobile stations to transmit the quality parameters back to the network device, and configuring the network device to assess the communication quality of the channels based on the received quality parameters.

Generally speaking, in order to assess the communication quality of the channels, the network device conventionally needs to stop servicing and switches to different channels for the channel measurement. Hence, as the channels increase in number, a downtime of the network device becomes longer.

In comparison, in the method of the present disclosure and the network system 1, a mobile station 12_x is configured to perform the channel measurement based on the packet sent by the network device 11 through the channel group and transmit the quality parameters back to the network device 11. Here, x is an integer from 1 to n. That is to say, since it is the mobile station 12_x that performs the channel measurement in the method of the present disclosure and the network system 1, the network device 11 only needs to switch to different channel groups for sending the packet. In this way, a downtime of the network device 11 can be reduced. In addition, each of the quality parameters can include one or a combination of a receiving signal strength, an error rate, and a channel utilization rate, but the present disclosure is not limited thereto.

In order to reduce the time taken by the mobile station 12_x to perform the channel measurement, when m is greater than or equal to n, step S110 can further include: configuring the network device 11 to evenly divide the channels CH_1 to CH_m into the channels groups that respectively correspond to the mobile stations 12_1 to 12_n. That is to say, a quantity of the channel groups can be equal to the quantity of the mobile stations 12_1 to 12_n. Hence, the channels CH_1 to CH_m can be divided into channel groups GP_1 to GP_n (not illustrated in FIG. 2), and the channel groups GP_1 to GP_n respectively correspond to the mobile stations 12_1 to 12_n, but the present disclosure is not limited thereto.

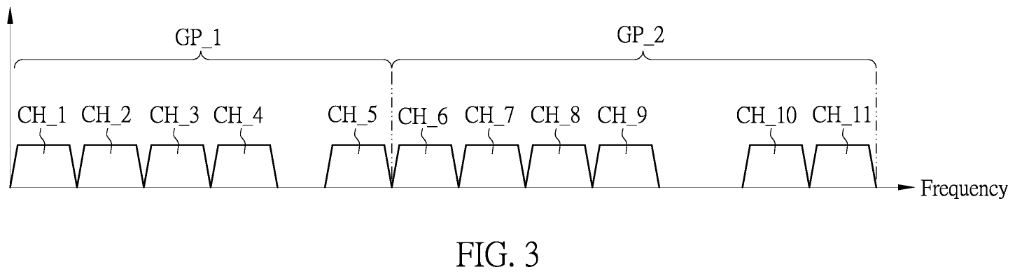

Specifically, in response to m being greater than n and the channels CH_1 to CH_m being evenly divided into the channel groups GP_1 to GP_n that respectively correspond to the mobile stations 12_1 to 12_n, a quantity of the channels included in each of the channel groups is at least [(m/n)], and [(m/n)] is less than or equal to a maximum integer of [(m/n)]. Reference can be made to, for example, FIG. 3. FIG. 3 is a schematic view showing eleven channels in a 5 GHz wireless network being evenly divided into two channel groups that respectively correspond to two mobile stations according to one embodiment of the present disclosure with the eleven channels having a 40 MHz bandwidth.

As shown in FIG. 3, when the network device 11 evenly divides the eleven channels CH_1 to CH_11 of the 40 MHz bandwidth that are in the 5 GHz wireless network into the two channel groups GP_1 to GP_2 that respectively correspond to the two mobile stations 12_1 to 12_2, [(m/n)]=[(11/2)]=5. As a result, a first one of the channel groups (GP_1) includes five of the channels (CH_1 to CH_5), and a second one of the channel groups (GP_2) includes the remaining six channels (CH_6 to CH_11). Then, the network device 11 can send the packet to the mobile station 12_1 through the channels CH_1 to CH_5 of the channel group GP_1, and sends the packet to the mobile station 12_2 through the channels CH_6 to CH_11 of the channel group GP_2.

The mobile station 12_1 can perform the channel measurement based on the packet sent by the network device 11 through the channels CH_1 to CH_5, and transmit the quality parameters of the channels CH_1 to CH_5 back to the network device 11. Similarly, the mobile station 12_2 can perform the channel measurement based on the packet sent by the network device 11 through the channels CH_6 to CH_11, and transmit the quality parameters of the channels CH_6 to CH_11 back to the network device 11. Therefore, in the method of the present disclosure and the network system 1, channel quantities of the channel groups are as equal to each other as possible, so as to effectively reduce the time taken by each of the mobile stations for the channel measurement.

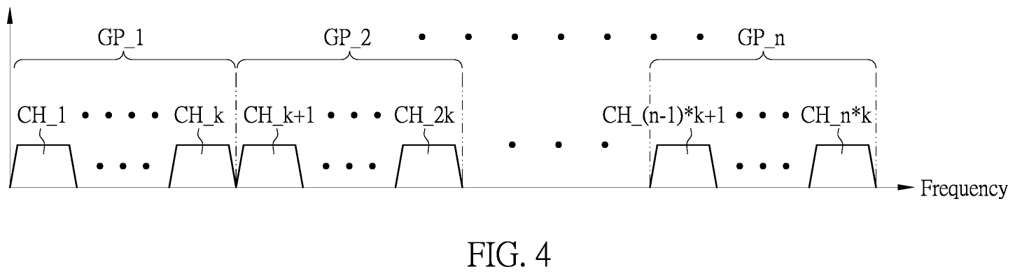

On this basis, in response to m being a multiple of n and the channels CH_1 to CH_m being evenly divided into the channel groups GP_1 to GP_n that respectively correspond to the mobile stations 12_1 to 12_n, the quantity of the channels included in each of the channel groups is [(m/n)]. Reference can be made to, for example, FIG. 4. FIG. 4 is a schematic view showing each channel group including (m/n) channels according to one embodiment of the present disclosure.

As shown in FIG. 4, the first one of the channel groups (GP_1) can include channels CH_1 to CH_k, and the second one of the channel groups (GP_2) can include channels CH_k+1 to CH_2k. Similarly, an nth one of the channel groups (GP_n) includes channels CH_(n−1)*k+1 to CH_n*k, in which k is (m/n). An xth one of the channel groups (GP_x) includes channels CH_(x−1)*k+1 to CH_x*k. Then, the network device 11 sends the packet to the mobile station 12_x through the channels CH_ (x−1)*k+1 to CH_x*k of the channel group GP_x. The mobile station 12_x can also perform the channel measurement based on the packet sent by the network device 11 through the channels CH_(x−1)*k+1 to CH_x*k, and transmit the quality parameters back to the network device 11. Detailed descriptions in this regard are already provided above, and thus will not be reiterated herein.

Specifically, in the method of the present disclosure and the network system 1, the network device 11 is configured to assign different mobile stations for measuring the quality parameters of the channels in different frequency bands. However, m may be less than n. Moreover, in the present disclosure, the channel groups are not limited to a specific quantity, and the channel groups and the mobile stations are also not limited to a specific corresponding relationship. Hence, in certain embodiments, the method of the present disclosure and the network system 1 only need to configure some of the mobile stations for measuring the quality parameters of the channels.

### Beneficial Effects of the Embodiments

In conclusion, in the method for assessing the channel quality and the network system provided by the present disclosure, the mobile station is configured to perform the channel measurement based on the packet sent by the network device through the channel group and transmit the quality parameters back to the network device, thereby reducing the downtime of the network device.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for assessing a channel quality, wherein the method is applicable to a network system, the network system includes a network device and a plurality of mobile stations, and the network device and the mobile stations wirelessly communicate with each other through a plurality of channels, the method comprising:
configuring the network device to divide the channels into a plurality of channel groups according to the corresponding mobile stations;
configuring the network device to send at least one packet through each of the channel groups to the corresponding mobile station for channel measurement, so as to obtain a plurality of quality parameters respectively for the channels; and
configuring the mobile stations to transmit the quality parameters back to the network device, and configuring the network device to assess a communication quality of the channels based on the received quality parameters.

2. The method according to claim 1, wherein a quantity of the channels is m, a quantity of the mobile stations is n, and m and n are each an integer greater than 1; wherein each of the quality parameters includes one or a combination of a receiving signal strength, an error rate, and a channel utilization rate.

3. The method according to claim 2, wherein, in response to m being greater than or equal to n, the step of configuring the network device to divide the channels into the channel groups according to the corresponding mobile stations includes:
configuring the network device to evenly divide the channels into the channels groups that respectively correspond to the mobile stations.

4. The method according to claim 3, wherein, in response to m being greater than n and the channels being evenly divided into the channel groups that respectively correspond to the mobile stations, the quantity of the channels included in each of the channel groups is at least [(m/n)], and [(m/n)] is less than or equal to a maximum integer of [(m/n)].

5. The method according to claim 3, wherein, in response to m being a multiple of n and the channels being evenly divided into the channel groups that respectively correspond to the mobile stations, the quantity of the channels included in each of the channel groups is [(m/n)].

6. A network system, comprising:
a plurality of mobile stations; and
a network device, wherein the network device and the mobile stations wirelessly communicate with each other through a plurality of channels, and the network device is configured to perform the following steps:
dividing the channels into a plurality of channel groups according to the corresponding mobile stations;
sending at least one packet through each of the channel groups to the corresponding mobile station for channel measurement, so as to obtain a plurality of quality parameters respectively for the channels; wherein the mobile stations are configured to transmit the quality parameters back to the network device; and
assessing a communication quality of the channels based on the received quality parameters.

7. The network system according to claim 6, wherein a quantity of the channels is m, a quantity of the mobile stations is n, and m and n are each an integer greater than 1; wherein each of the quality parameters includes one or a combination of a receiving signal strength, an error rate, and a channel utilization rate.

8. The network system according to claim 7, wherein, in response to m being greater than or equal to n, the step of configuring the network device to divide the channels into the channel groups according to the corresponding mobile stations includes:
evenly dividing the channels into the channels groups that respectively correspond to the mobile stations.

9. The network system according to claim 8, wherein, in response to m being greater than n and the channels being evenly divided into the channel groups that respectively correspond to the mobile stations, the quantity of the channels included in each of the channel groups is at least [(m/n)], and [(m/n)] is less than or equal to a maximum integer of [(m/n)].

10. The network system according to claim 8, wherein, in response to m being a multiple of n and the channels being evenly divided into the channel groups that respectively correspond to the mobile stations, the quantity of the channels included in each of the channel groups is [(m/n)].
